(19) United States
(12) Patent Application Publication
(10) Pub. No.: US 2026/0310605 A1
(43) Pub. Date: Oct. 8, 2026

(54) CACHE COMPRESSION CONTROL

(71) Applicant: Arm Limited, Cambridge (GB)

(72) Inventors: Kevin Neal MAGILL, Durham, NC (US); Walker Peterson WILLETTS, Raleigh, NC (US); Klas Magnus BRUCE, Leander, TX (US)

(21) Appl. No.: 19/170,207

(22) Filed: Apr. 4, 2025

(51) Int. Cl. G06F 12/0871; G06F 12/0891; G06F 12/0895

(52) U.S. Cl. CPC G06F 12/0871; G06F 12/0891; G06F 12/0895

(57) ABSTRACT

Apparatuses, systems, methods, computer-readable media, and computer code are disclosed. An apparatus comprises a cache comprising N data storage locations to hold cache lines; and M tag storage locations to hold address tags of cache lines. Each address tag is associated with a data field configured to support at least one of: a pointer encoding to indicate one of the N data storage locations into which a corresponding cache line is allocated and a compressed-data encoding to represent a predetermined value. Compression control circuitry is responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.

### TECHNICAL FIELD

The present disclosure relates to data processing. In particular, the present disclosure relates to allocating cache lines in a cache.

### DESCRIPTION

A data processing apparatus may provide one or more caches for temporarily storing data that has recently been loaded from memory, so that subsequent accesses to that data may be performed with reduced latency. By holding more data in the cache, it may be more likely that data requested by a subsequent memory access will be present. However, increasing the capacity of the cache comes at some hardware cost such as increased circuit area and power consumption.

### SUMMARY

In one example embodiment described herein there is provided an apparatus comprising: a cache comprising: N data storage locations, configured to hold cache lines; and M tag storage locations, configured to hold address tags of cache lines, wherein each address tag is associated with a data field configured to support at least one of: a pointer encoding to indicate one of the N data storage locations into which a corresponding cache line is allocated; and a compressed-data encoding to represent a predetermined value; and compression control circuitry responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.

In another example embodiment described herein there is provided a system comprising: the apparatus as described above implemented in at least one packaged chip; at least one system component; and a board, wherein the at least one packaged chip and the at least one system component are assembled on the board. In another example embodiment described herein there is provided a chip-containing product comprising the system described above, wherein the system is assembled on a further board with at least one other product component.

In another example embodiment described herein there is provided a method comprising: holding cache lines in N data storage locations; holding address tags of cache lines in M tag storage locations, wherein each address tag is associated with a data field supporting at least one of: a pointer encoding to indicate one of the N data storage locations into which a corresponding cache line is allocated; and a compressed-data encoding to represent a predetermined value; and in response to determining that a given cache line to be allocated into the cache contains the predetermined value, setting the data field associated with a given address tag corresponding to the given cache line to the compressed-data encoding to represent the predetermined value and suppressing storage of the given cache line in any of the N data storage locations.

In another example embodiment described herein there is provided a non-transitory computer-readable medium storing computer-readable code for fabrication of an apparatus comprising: N data storage locations, configured to hold cache lines; and M tag storage locations, configured to hold address tags of cache lines, wherein each address tag is associated with a data field configured to support at least one of: a pointer encoding to indicate one of the N data storage locations into which a corresponding cache line is allocated; and a compressed-data encoding to represent a predetermined value; and compression control circuitry responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.

### BRIEF DESCRIPTION OF THE DRAWINGS

The present invention will be described further, by way of example only, with reference to embodiments thereof as illustrated in the accompanying drawings, in which:

FIG. 1 illustrates a data processing apparatus comprising several caches according to some example embodiments;

FIG. 2A illustrates an apparatus comprising a cache with tag storage locations and data storage locations according to some example embodiments;

FIG. 2B illustrates a tag storage location entry according to some example embodiments;

FIG. 3 illustrates examples of pointer encodings and compressed-data encodings according to some example embodiments;

FIG. 4 illustrates dynamically associable tag storage locations and data storage locations according to some example embodiments;

FIG. 5 illustrates statically associated tag storage locations and data storage locations according to some example embodiments;

FIG. 6 illustrates a sequence of steps for reading data from a cache according to some example embodiments;

FIGS. 7A and 7B illustrate sequences of steps for writing compressible and non-compressible data to the cache according to some example embodiments;

FIG. 8 illustrates sequence of steps for evicting an entry from one cache to a lower cache according to some example embodiments;

FIG. 9 illustrates a system and a chip-containing product according to some example embodiments;

FIG. 10 illustrates the use of a computer-readable medium for manufacturing an apparatus according to some example embodiments.

### DESCRIPTION OF EXAMPLE EMBODIMENTS

Before discussing the embodiments with reference to the accompanying figures, the following description of embodiments is provided.

An apparatus may be provided with a cache comprising N data storage locations configured to hold cache lines, and M tag storage locations configured to hold address tags of cache lines. In the following description, it will be appreciated that N and M are placeholders for values representing the arrangement of a cache in hardware. For example, N and M may represent the associativity of a cache implementation, where a 4-way set-associative cache may comprise 4 data storage locations (i.e. N=4) into which a particular cache line may be allocated.

The size of a cache line may vary in different implementations, and some examples may include cache lines of 64 bytes or more. To reduce the necessary capacity to hold cache lines, some approaches may implement data compression by encoding cache lines into a smaller size. Various approaches are used, which may require complex codecs, accesses to multiple data storage locations for a single cache line, or re-organising the associativity of the cache. A problem with such approaches is that reading and writing data in the cache requires complex logic to encode or decode the cache line when accessing the cache, thus incurring additional latency and power consumption, thereby reducing the performance of the cache.

In accordance with the present techniques, the address tags held in the tag storage locations are associated with a data field. The data field is configured to support at least one of: a pointer encoding to indicate one of the N data storage locations, into which a corresponding cache line is allocated; and a compressed-data encoding to represent a predetermined value. In some examples, the data field may support plural compressed-data encodings, where each compressed-data encoding represents a different predetermined value. The number of available compressed-data encodings may depend on the size of the data field. It will be appreciated that, by providing encodings for one or more specific predetermined values, it is not necessary to include complex logic for applying a codec to encode/decode data more generally. Accordingly, in the following description, a cache line that contains the predetermined value may be described as “compressible”, whereas a cache line that does not contain the predetermined value may be described as “incompressible” (i.e. at least for the purposes of the present techniques -data that does not contain the predetermined value may be compressible using other cache compression methods).

The apparatus is further provided with compression control circuitry that is responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations. Accordingly, the predetermined value is effectively stored (by storing an encoding representing that value) in a tag storage location instead of in a data storage location. Since the purpose of the pointer encoding is not needed when using the compressed-data encoding (i.e. because the given cache line is not stored in any of the N data storage locations), the data field is provided with a dual purpose depending on whether a corresponding cache line contains the predetermined value or not. Accordingly, the present techniques implement the tag storage locations to use the same data field for both encodings, thereby reducing the overall circuit area required for storing a cache line in both a compressed form (i.e. represented by the compressed-data encoding) and an uncompressed form (i.e. in a data storage location indicated by the pointer encoding).

In some examples, the cache is arranged such that M=N (i.e. there are the same number of data storage locations and tag storage locations). In such examples, setting the data field of a tag storage location to the compressed-data encoding may leave one data storage location unused (i.e. due to a tag storage location not being available to indicate that data storage location with the pointer encoding). This may provide a small power saving since a data storage location no longer needs to be accessed.

In other examples, the cache is arranged such that M>N (i.e. there are more tag storage locations than data storage locations). It will be appreciated that a data storage location may be configured to have a larger storage capacity than a tag storage location, since a tag storage location is typically not required to hold as much data as a data storage location. For example, a tag storage location may be required to hold an address tag, the data field described above and some associated metadata, all of which may only amount to several bytes. On the other hand, a data storage location would be required to hold an entire cache line which, as above, may be as large as, say, 64 bytes. Accordingly, the hardware cost of including one or more additional tag storage locations is minimal compared to including one additional data storage location. By setting the data field of an additional tag storage location to the compressed-data encoding as described above, a tag storage location may be used to embody a data storage location holding a cache line containing the predetermined value. Hence, at least when holding cache lines containing the predetermined value, the capacity of the cache is effectively increased as though there were additional data storage locations, while only incurring the hardware cost of additional tag storage locations.

In some examples, the compression control circuitry is responsive to a determination that the given cache line does not contain the predetermined value to permit the given cache line to be allocated into a selected one of the N data storage locations, and set the data field of a selected tag storage location to the pointer encoding to indicate the selected one of the N data storage locations. Accordingly, cache lines that do not contain the predetermined value are held in a data storage location. By setting the data field of a selected tag storage location to the pointer encoding to indicate that data storage location, the data storage location holding the given cache line may be easily located when performing a lookup in the tag storage locations.

In some examples, the apparatus is provided with read circuitry configured to receive a read request to read target data at a requested memory address. The read request may be from an architectural source (e.g. a load/store unit after execution of a load instruction by a data processing apparatus), or from a micro-architectural source (e.g. a prefetcher predicting that a memory access will target the requested memory address in the future). The read circuitry may perform a lookup in the M tag storage locations to identify a hit address tag corresponding to the requested memory address. In response to identifying the hit address tag and the data field associated with the hit address tag containing the compressed-data encoding, the read circuitry is configured to provide the predetermined value as a response to the read request.

In some examples, the read circuitry is configured to provide the predetermined value without accessing the N data storage locations. For example, the read circuitry may inject the predetermined value directly into the datapath for responding to the read request. Accordingly, both power consumption and latency can be reduced.

In some examples, in response to the data field associated with the hit address tag containing the pointer encoding, the read circuitry is configured to retrieve the target data from the one of the N data storage locations indicated by the pointer encoding. This allows the read circuitry to retrieve data that is not the predetermined value.

In some examples, the apparatus is provided with write circuitry configured to receive a write request to write target data to a specified memory address. As above, the write request may also be from an architectural or micro-architectural source. The write circuitry may perform a lookup in the M tag storage locations to identify a target address tag corresponding to the specified memory address. The functionality of writing the data to the cache may then depend on whether the target address tag is associated with a data field containing the compressed-data encoding or pointer encoding, and whether the write target data is the predetermined value. In particular, if the target address tag is associated with a data field containing the compressed-data encoding and the write target data is not the predetermined value, then the cache line may be “decompressed” so that the write target data can be stored. The decompression includes setting the data field to the pointer encoding to indicate an available one of the N data storage locations, and then allocating the write target data into the available one of the N data storage locations. It will be appreciated that a data storage location may be available, e.g. while the cache is still warming up after the system powers on or after some previously cached data has been invalidated. However in some examples, if it is determined that there are no available data storage locations, the write circuitry may cause an existing cache line to be evicted from one of the N data storage locations. Various eviction policies may be employed for this eviction, such as least recently used (LRU), first-in first-out (FIFO) or re-reference interval prediction (RRIP), etc. Once a data location is made available, the write target data may be allocated as above.

In some examples, such as in a case where the write target data is the predetermined value, the write circuitry is configured to set the data field associated with the target address tag to the compressed-data encoding. It will be appreciated that, in implementations that provide for a plurality of compressed-data encodings for representing a plurality of predetermined values, the write target data may contain a different one of the predetermined values that was already represented. Hence, setting the compressed-data encoding may include verifying that the correct compressed-data encoding has been set, or setting a different compressed-data encoding.

It will also be appreciated that, if no target address tag is identified by the write circuitry, then the write target data may be allocated to the cache as a new cache line under the control of the compression control circuitry as described above.

In some examples, the apparatus is provided with eviction circuitry configured to select an eviction victim to be evicted from the cache in response to the given cache line being allocated into the cache. According to the present techniques, the eviction circuitry may select the eviction victim in dependence on whether the given cache line to be allocated contains the predetermined value. This dependence may be included as part of any other eviction policy, such as those mentioned above.

In some examples, the cache is further provided with priority metadata storage configured to hold eviction victim priority metadata in association with each of the M tag storage locations. The priority metadata storage may comprise M priority metadata storage locations, each corresponding to different ones of the M tag storage locations. In some examples, the M priority metadata storage locations may be a further metadata field contained in the M tag storage locations. Alternatively, a single storage location may be provided with capacity to track the metadata for each of the M tag storage locations. The eviction circuitry may then select the eviction victim in dependence on the eviction victim priority metadata. In this way, the eviction priority is tracked with respect to the M tag storage locations (i.e. rather than the N data storage locations). In particular examples where M>N, this allows all cache entries (including both compressed and uncompressed entries) to be tracked for eviction purposes.

In some examples, the eviction circuitry is responsive to the given cache line containing the predetermined value to prioritise, for selection of the eviction victim, address tags associated with the compressed-data encoding. This allows the cache to retain cache lines which do not contain the predetermined value where possible, thereby allowing more effective usage of the N data storage locations. It will be appreciated that, if there are no address tags associated with the compressed-data encoding, then an address tag associated with the pointer encoding may be evicted instead. This, in turn, causes the data location indicated by the pointer encoding to no longer be used.

On the other hand, the eviction circuitry may be responsive to the given cache line not containing the predetermined value to prioritise, for selection of the eviction victim, address tags associated with the pointer encoding and the cache line at the data location indicated by that pointer encoding. This allows the cache to retain cache lines that contain the predetermined value where possible.

According to these above examples, the eviction circuitry may prioritise replacing compressible data with compressible data and replacing incompressible data with incompressible data.

In some examples, the present techniques may be applied to multiple caches in the same system. For example, the apparatus may be provided with a second cache, configured to store entries that are evicted from the (first) cache (e.g. an L1 cache and L2 cache). The second cache comprises at least one second tag storage location configured to store an address tag in association with a second data field configured to support at least the compressed-data encoding. In some examples, the second cache may be arranged in the same way as the first cache, but with larger values for N and M to accommodate more cached data. In response to the cache evicting an entry comprising an address tag associated with the compressed-data encoding from one of the M tag storage locations, the second cache may store the entry in the at least one second tag storage location and set the second data field to the compressed-data encoding. Accordingly, when compressible data is evicted from the first cache and allocated to the second cache, the data does not need to be uncompressed. Hence, it is not necessary to transmit the full cache line containing the predetermined value between the caches, thereby reducing bandwidth in the memory system.

In the above examples, the predetermined value may be any value selected in the particular implementation. For example, a value which occurs particularly frequently in a given workload may be chosen as the predetermined value to be represented by a compressed-data encoding. In some examples, the predetermined value may be all zeros or all ones. As mentioned above, a plurality of compressed-data encodings may be provided to hold both of these, e.g. one encoding for all zeros and one encoding for all ones.

In some examples, at least one of the M tag storage locations contains a data field that is configured to exclusively support the compressed-data encoding. In other words, the at least one of the M tag storage locations does not support the pointer encoding. Accordingly, the at least one of the M tag storage locations may be used as a dedicated storage location for compressible data, while the other tag storage locations may be used to hold incompressible data by using the pointer encoding.

In some examples, the compression control circuitry is configured to suppress setting the data field to the compressed-data encoding in response to a given machine state. It will be appreciated that data that has already been stored as a compressed-data encoding may be kept and read (e.g. based on the example of read circuitry described above). However, a newly allocated cache line may be prevented from being stored as a compressed-data encoding, even if it contains the predetermined value.

In some examples, the given machine state is determined based on a value stored in a system register. A system register may be modifiable only by a supervisory process with an elevated level of privilege (e.g. an operating system or hypervisor). Hence, these processes may have the capability to deactivate the compression functionality if required.

In some examples, the compression control circuitry is configured to suppress setting the data field to the compressed-data encoding in response to the given cache line containing a predetermined type of data. Such predetermined types of data may be those which are known to rarely or never contain the predetermined value (e.g. memory protection tags or prefetcher metadata). Furthermore, data which is inclusive with other caches (i.e. duplicated data stored in multiple caches), may be preferable to keep in uncompressed form.

Particular embodiments will now be described with reference to the figures.

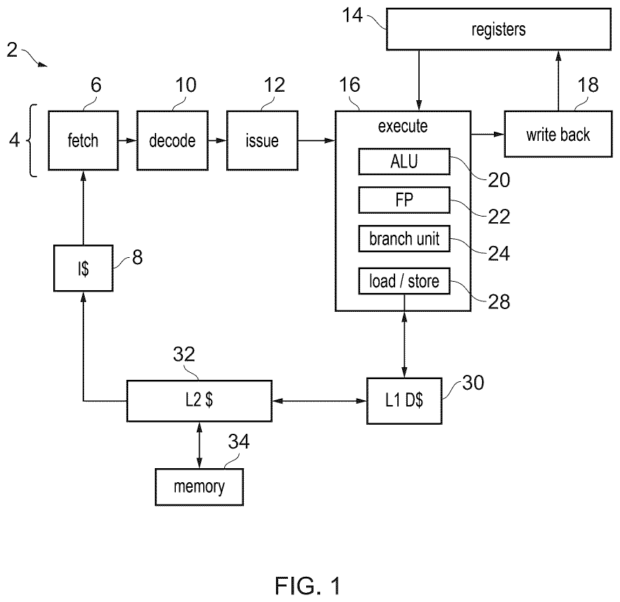

FIG. 1 schematically illustrates an example of a data processing apparatus 2. The data processing apparatus has a processing pipeline 4, which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that the present techniques relate generally to the arrangement of a cache and hence may be applied to any one or more of the caches 8, 30, 32. Accordingly, while the following description will primarily refer to the cache 30 for conciseness, it will be understood that the same features may also be present in the instruction cache 8, the level 2 cache 32 or a level 3 cache (not illustrated).

It will also be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

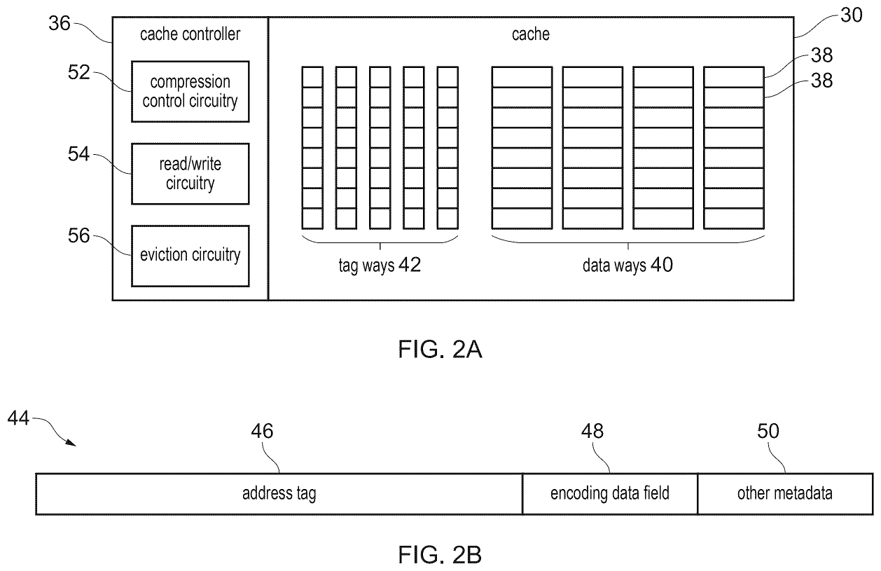

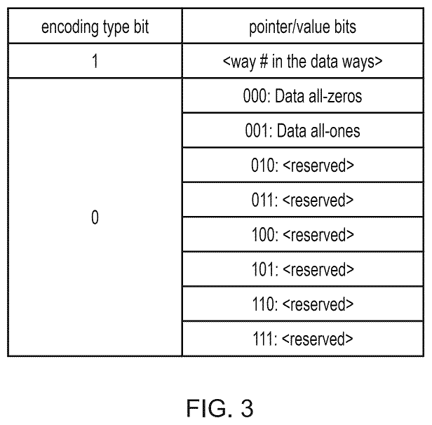

FIG. 2A illustrates an example arrangement of an apparatus comprising a cache 30 according to the present techniques. The cache 30 comprises a set-associative arrangement with 8 sets 38 for storing cached data. For a cache having associativity A, this means that the number of entries (each holding a cache line) in one set 38 is A. Such a cache may be described as an “[A]-way” set-associative cache and the entries can also be considered to be logically grouped into “ways”, such as the data ways 40, where each set 38 comprises one entry from each data way 40. In this example, the cache 30 comprises 4 data ways 40, hence the cache 30 is 4-way set-associative for data. In addition to the data ways 40, the cache 30 comprises tag ways 42. As shown, the number of tags ways may be greater than the number of data ways. In this example, the cache 30 comprises 5 tag ways 42, hence the cache 30 is 5-way set-associative for address tags.

The set-associative placement policy used for such a cache means that when data having a given address needs to be allocated into the cache, it is placed in one of the entries within a particular set 38 that is selected based on an index value computed based on the given address. In some cases, the index may simply be a portion of bits extracted from the given address, while in other examples the index could be based on a more complicated function of the given address (e.g. applying a hash function to the given address to obtain the index value). Hence, data associated with a given address cannot be stored in entries of sets 38 other than the set corresponding to the index selected based on the given address. This is useful because it reduces the number of entries of the cache which have to be checked to determine whether the cache stores data associated with a specified target address, but in comparison to a direct-mapped cache (where data for a given address can only be allocated to a single entry selected based on the address), the set-associative placement scheme improves performance as there is flexibility to allocate data for a given address to two or more locations, which reduces the likelihood of thrashing as it means two or more different addresses mapping to the same set can each be cached simultaneously. Each entry may specify a data value, which is the information of interest stored in the cache entry. The data value could be data or instructions, or could be address mapping information cached in a translation lookaside buffer, for example. According to this example, the 4 entries in a given set 38 of the data ways 40 may correspond to the N data storage locations defined in the appended claims (i.e. N=4).

Each entry stored in the cache may correspond with an address tag, which is held in a set 38 (which may also be determined based on the index as described above) of one of the tag ways 42. Hence, the 5 entries in a given set 38 of the tag ways 42 may correspond to the M tag storage locations defined in the appended claims (i.e. M=5). An example of a tag entry 44 is shown in FIG. 2B, and comprises an address tag 46 which corresponds to a portion of the memory address which is not used to generate the index, and is stored in an entry in a set 38 of the tag ways 42. The tag entry 44 also comprises an encoding data field 48, which is capable of supporting one or both of a pointer encoding used to identify one of the data ways 40 in which the data corresponding to the address tag 46 is located, or a compressed-data encoding used to represent a predetermined value. Specific examples of such encodings will be described later. The tag entry 44 may also state other metadata 50 associated with the memory address, such as a valid indicator indicating whether the corresponding data is valid, coherency state information (e.g. a dirty bit indicating whether the corresponding data has been modified compared to the corresponding data value in a lower level cache (e.g. L2 or L3 cache) or memory), or eviction priority information for selecting a victim cache entry when an entry needs to be evicted from the cache. It will be appreciated that the tag entry 44 may comprise only a few bytes, depending on how much of the memory address is used to define the address tag 46 and how much other metadata 50 is required. Accordingly, the each of tag ways 42 come at a lower hardware cost than each of the data ways 40.

Returning to FIG. 2A, the cache 30 is coupled with a cache controller 36, which comprises several functional units for controlling access to and allocation of data to the cache 30. In this example, the cache controller 36 comprises compression control circuitry 52, read/write circuitry 54, and eviction circuitry 56. The compression control circuitry 52 is responsive to a determination of whether a given cache line to be allocated into the cache contains the predetermined value. The predetermined value may be any value for which there is a compressed-data encoding supported by the data field 48 to represent that value. Hence, what the compression control circuitry 52 identifies as the predetermined value may vary between implementations, and even between caches in a given memory system. In response to a determination that the given cache line contains the predetermined value, the compression control circuitry 52 controls the allocation of an address tag 46 corresponding to the given cache line to a tag entry 40 in the tag ways 42. The compression control circuitry 52 then sets the data field 48 to the compressed-data encoding to represent the predetermined value. Since the tag entry 44 now effectively holds the given cache line (or a representation thereof), it is not necessary to store the given cache line in the data ways 40. Accordingly, the compression control circuitry 52 suppresses storage of the given cache line into the data ways 40.

In accordance with the above technique, cache lines, which may be as large as 64 bytes, may be compressed for storage in a tag entry 44, which may be only a few bytes in comparison. Hence, by providing one additional tag way 42, the cache 30 is effectively capable of storing one additional way's worth of cache lines containing the predetermined value. It will be appreciated that the additional way's worth of capacity depends on the difference between the number of tag ways 42 (M) and the number of data ways 40 (N). One particular implementation is for M=1.25 ×N as shown in FIG. 2A, however other implementations are also possible.

On the other hand, if the given cache line to be allocated into the cache does not contain the predetermined value, then the compression control circuitry 52 sets the data field 48 to the pointer encoding instead of the compressed-data encoding. The pointer encoding indicates one of the data ways 40, to which the given cache line is stored. It will be appreciated that it is not necessary for the pointer encoding to also specify a set 38, because this is can be identified by the index as described above. This therefore provides caching functionality for any data that is not the predetermined value.

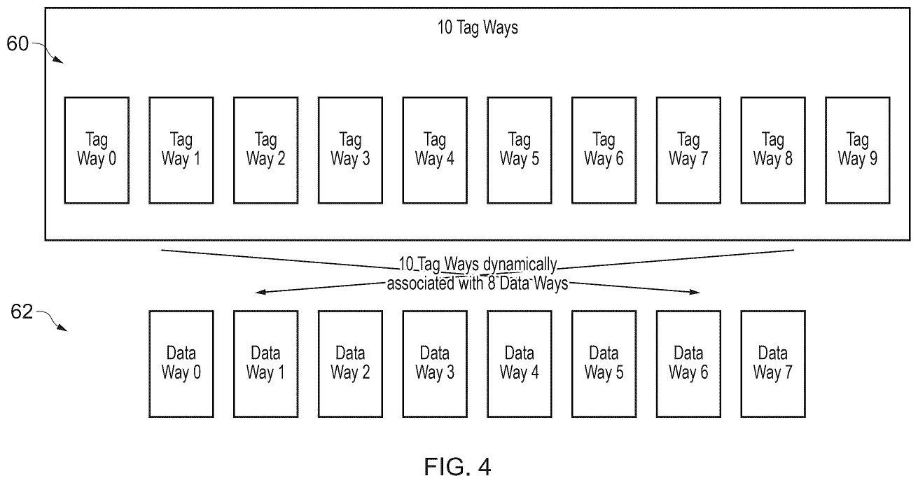

FIG. 3 illustrates some examples of encodings that may be supported by the data field 48. In this example, the data field 48 comprises a nibble (i.e. 4 bits). The first bit identifies the encoding type, where a 1 indicates a pointer encoding and a 0 indicates a compressed-data encoding. For a pointer encoding, the remaining 3 bits represent pointer bits identifying one of the data ways 40. For a compressed-data encoding, the remaining 3 bits are used to represent the predetermined value. In this example, there are encodings for all-zeros and all-ones. This example also provides a number of ‘reserved’ encodings, which may be implementation specific. For example, if a particular value was particularly frequent in a given workload, then that value may be assigned one of the reserved compressed-data encodings (i.e. that value becomes ‘the predetermined value’). Accordingly, that value may be compressed to take advantage of the increased effective capacity of the cache 30 more frequently.

It will be appreciated that since FIG. 3 provides 4 bits for the data field 48, the pointer encoding may point to up to 8 different data ways (i.e. because 3 bits are provided for the pointer bits). For the cache 30 in FIG. 2A, the data field 48 may be reduced to only 3 bits, so that 2 pointer bits are provided to point to any of the 4 data ways 40. Furthermore, for a cache with more data ways, the data field 48 may be larger to accommodate more pointer bits. Since those pointer bits serve a dual purpose as the value bits for the compressed-data encodings, there are also more possible compressed-data encodings that may be supported. Hence, a larger cache having more ways may also support compression of a larger number of predetermined values.

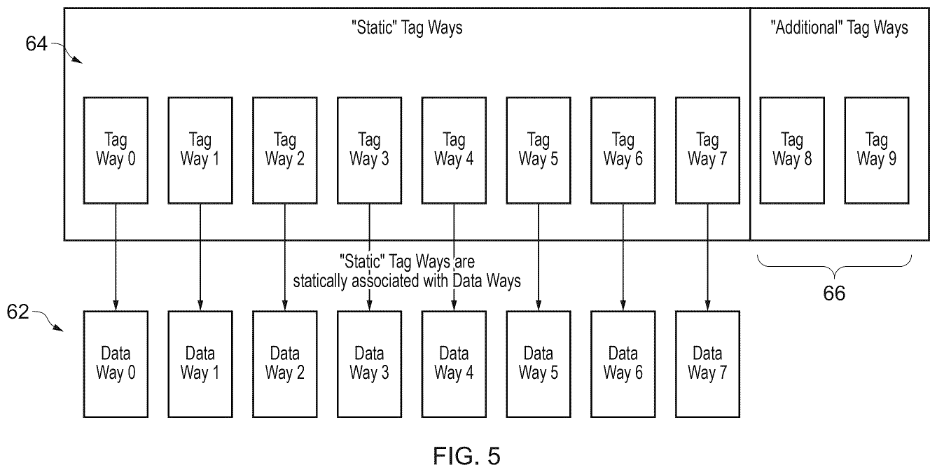

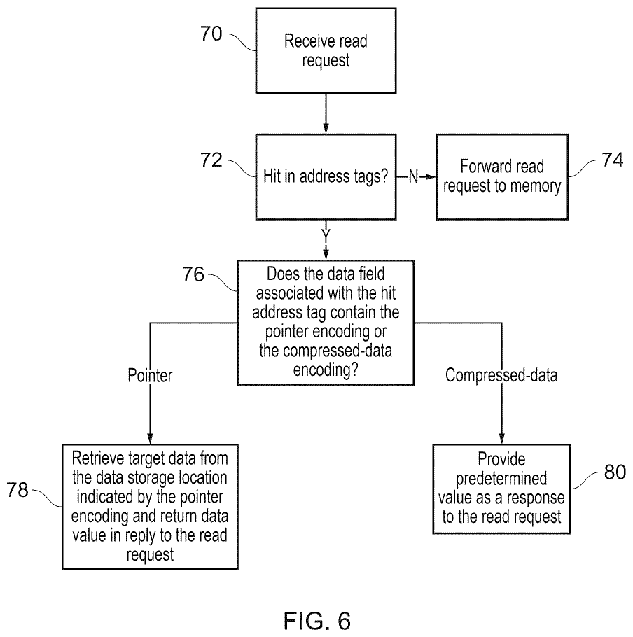

By using the pointer encoding described above, it is possible for individual tag ways to be dynamically associable with different data ways. FIG. 4 illustrates another example of a cache comprising 10 tag ways 60 and 8 data ways 62. As shown, each of the tag ways 60 can be associated with any of the data ways 62. This arrangement allows for flexibility of whether to use any given tag way 60 for pointing to a data way 62 or for holding a predetermined value based on the compressed-data encoding. However, it is not necessary for all tag ways in the cache to be capable of supporting both pointer and compressed-data encodings. FIG. 5 illustrates another example where the tag ways comprise statically associable tag ways 64 and additional tag ways 66. The statically associable tag ways may be fixed to provide pointers for one particular data ways 62. In some examples, the static tag ways 64 may not explicitly define a pointer, and instead an address tag in, e.g. tag way 3 is implicitly taken to correspond with a cache line stored in data way 3, tag way 4 is implicitly taken to correspond with a cache line stored in data way 4, and so on. The additional tag ways 66 are not associated with any data ways and hence may be used with a data field 48 to exclusively support the compressed-data encodings (i.e. and does not support a pointer encoding). Accordingly, the additional tag ways 66 provide dedicated tag storage locations in which the predetermined value may be represented by compressed-data encodings.

It will be appreciated that the examples of FIGS. 4 and 5 are just two examples, and other possible implementations may be possible. Indeed, some examples may combine these two implementations, such that there are some tag ways which are dynamically associable with data ways as shown in FIG. 4, and at least one tag way which is not associable with a data way (i.e. at least one tag way with a data field that exclusively supports the compressed-data encoding) for dedicated storage of compressed data as shown in FIG. 5. It will be appreciated therefore, that there are many different possible implementations of the tag ways to provide varying levels of flexibility for storing compressed or uncompressed data in accordance with the present techniques.

Returning to FIG. 2A, the cache controller is further provided with read/write circuitry 54, which is configured to receive read requests and/or write requests and then handle the requested access to the cached data. Such requests may be received from the load/store unit 28 or may be a line fill request from another level of cache. Read/write requests may specify a target address, from which the read/write circuitry 54 derives an index value as described above, to select a set 38 of the tag ways 42. Each address tag 46 in the entries of the selected set 38 is then compared with the tag portion of the target address. If any of the address tags 46 match the tag portion of the target address then it is determined that the data being targeted by the request is held in the cache (i.e. either in a data way 40 or as a compressed-data encoding in a tag way 42). This is referred to as a cache hit. On the other hand, if none of the address tags 46 in the selected set 38 match the tag portion of the target address, then there is a cache miss. In this case, the information associated with the target address may need to be fetched from a further data store, such as a further level of cache 32 or the main memory 34.

When there is a cache hit, an address tag may be identified as a hit address tag or target address tag corresponding to the requested address. The read/write request is subsequently handled differently depending on if a hit address tag is associated with a data field 48 that contains the pointer encoding or the compressed-data encoding.

For a read request, the read/write circuitry 54 responds to the hit address tag 46 being associated with a data field 48 containing the pointer encoding to access the pointed-to data way 40 at the same set 38 (i.e. using the same index derived to lookup the tag ways 42), to retrieve the requested cache line, and returns the cache line as a reply to the read request. On the other hand, if the hit address tag 46 is associated with a data field 48 containing the compressed-data encoding, the read/write circuitry 54 is configured to generate the predetermined value as a reply to the read request without accessing any of the data ways 40. For example, in a particular example where the read/write circuitry 54 is for the level 1 data cache 30, and is responding to a read request from the load/store unit 28, the predetermined value may be injected directly into the data lines between the load/store unit 28 and the cache 30. The read/write circuitry 54 may therefore include hardware logic for generating the predetermined value in response to the compressed-data encoding. It will be appreciated therefore that reading compressed data from the tag ways 42 does not require access to the data ways 40, which provides a saving in power consumption for performing each read request.

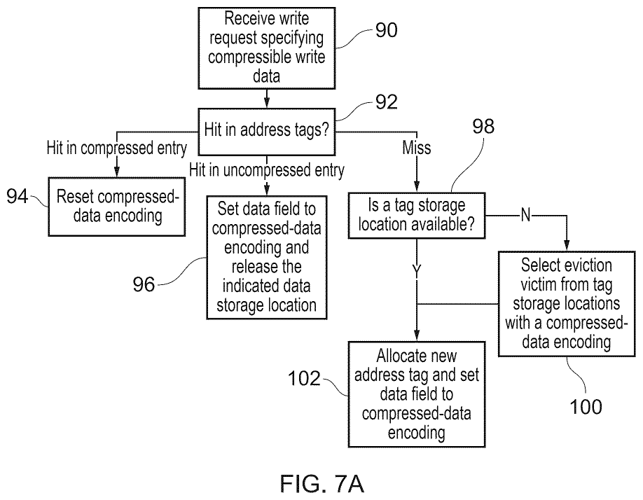

FIG. 6 illustrates a series of steps for the read/write circuitry 54 to respond to a read request. At step 70, the read request is received. As above, the read request specifies a requested memory address at which the read target data is located. At step 72, a lookup is performed to determine if there is a hit in the address tags. If not, then at step 74, the read request is forwarded towards memory 34 or a lower level of cache. If there is a hit in the address tags, then at step 76, it is determined whether the data field associated with the hit address tag contains the pointer encoding or the compressed-data encoding. If the data field contains the pointer encoding, then at step 78, the read/write circuitry 54 retrieves the target data from the data storage location indicated by the pointer encoding, and returns that data value in reply to the read request. If the data field contains the compressed-data encoding, then at step 80, the read/write circuitry 54 provides the predetermined value as a response to the read request, e.g. by injecting the predetermined value directly into the data lines.

For a write request, the way in which the read/write circuitry 54 handles the request is further dependent on whether the write data itself is compressible (i.e. contains the predetermined value). If the write data is compressible, then the write data may be written by setting the data field 48 associated with the hit address tag to the compressed-data encoding. Accordingly, if the data field 48 was previously pointing to a data way 40, that data way 40 is ‘released’ such that it may be made available to be pointed to by a different tag way 42. If there is a miss in the tag ways 42 (i.e. the address tag is not present), then the compressed-data encoding is set in an available tag way 42 in association with the new address tag corresponding to the address specified in the write request. If there are no tag ways 42 available, then the read/write circuitry 54 may trigger the eviction circuitry 56 to select an entry of the tag ways 42 as an eviction victim. Since the incoming data to be allocated to the cache is compressible, the eviction circuitry 56 may prioritise evicting address tags that are associated with a compressed-data encoding, so that data currently held in the data ways 40 is not disturbed.

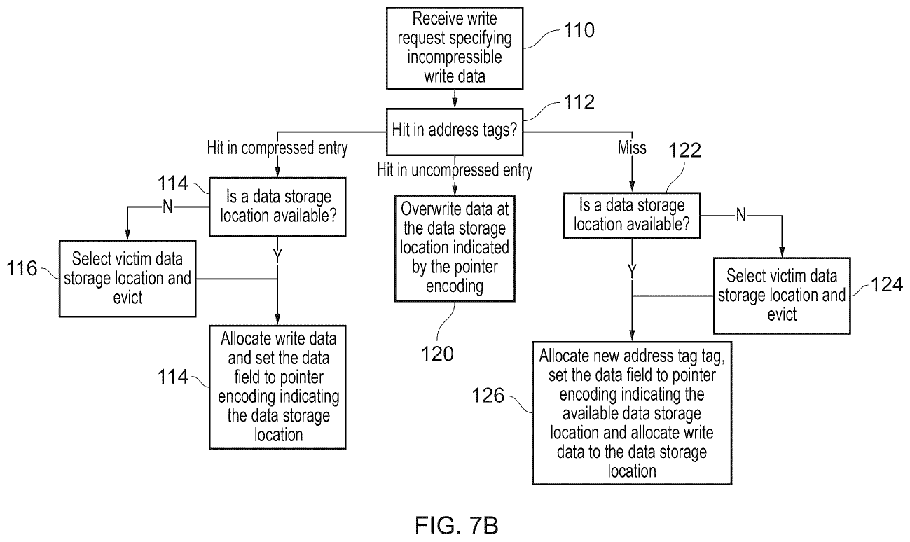

FIG. 7A illustrates a series of steps for the read/write circuitry 54 to respond to a write request that specifies compressible write data. At step 90, the write request is received. As above, the write request specifies a memory address to which the write target data is to be written. At step 92, a lookup is performed to determine if there is a hit in the address tags. If a hit address tag is located in a compressed entry (i.e. an address tag associated with the compressed-data encoding), then the compressed-data encoding is reset at step 94. It will be appreciated that, in examples where there are plural predetermined values and hence plural compressed-data encodings, step 94 may comprise setting the same compressed-data encoding or a different compressed-data encoding compared to that which was already set. If a hit address tag is located in an uncompressed entry (i.e. an address tag with the pointer encoding), then the pointer encoding is overwritten with the compressed-data encoding, thereby releasing the indicated data storage location, e.g. to be pointed to by a data field of a different tag storage location.

If step 92 results in a miss, then it is determined whether there are any tag storage locations available at step 98. If not, then an eviction process is started. In particular, at step 100, an eviction victim is selected from the tag storage locations, prioritising those with a compressed-data encoding. Although not illustrated, it will be appreciated that there if there are no tag storage locations with a compressed-data encoding, then an eviction victim will be selected from the tag storage locations with a pointer encoding. Accordingly, a tag storage location is made available and, at step 102, the new address tag (corresponding with the memory address specified in the write request) is allocated and the associated data field 48 is set to the compressed-data encoding, e.g. under the control of the compression control circuitry 52.

Alternatively, if the write data is not compressible, then the write data is written to a data way 40. If the hit address tag is a compressed entry (i.e. associated with the compressed-data encoding), then the entry may have to be decompressed to write the incompressible data. Accordingly, when writing the write data to an available data way, the data field 48 is set to the pointer encoding to point to that data way. If there are no available data ways 40, then the read/write circuitry 54 may trigger the eviction circuitry 56 to select an entry of the data ways 40 as an eviction victim. Since the incoming data to be allocated to the cache is not compressible, the eviction circuitry 56 may prioritise evicting address tags that are associated with a pointer encoding in the tag ways 42 and the corresponding cache line in the data ways 40. Accordingly, data currently represented as compressed-data encodings in the tag ways 42 is not disturbed.

FIG. 7B illustrates a series of steps for the read/write circuitry 54 to respond to a write request that specifies incompressible write data. At step 110, the write request is received. As above, the write request specifies a memory address to which the write target data is to be written. At step 112, a lookup is performed to determine if there is a hit in the address tags. If a hit address tag is located in a compressed entry (i.e. an address tag associated with the compressed-data encoding), then the compressed entry may be decompressed to allow the incompressible data to be allocated. Therefore, at step 114, it is determined whether a data storage location is available. If not, then an eviction process is started. In particular, at step 116, an eviction victim is selected from the data storage locations. This implicitly also selects, as an eviction victim, a corresponding tag storage location that is associated with a pointer encoding identifying that the selected data storage location. Accordingly, a data storage location is made available and, at step 118, the write data is allocated to the data storage location, and the data field 48 of the corresponding tag entry is set to the pointer encoding to indicate the allocated data storage location.

If, at step 112, a hit address tag is located in an uncompressed entry (i.e. an address tag associated with the pointer encoding), then it is not necessary to decompress the compressed entry. Instead, the data location that is currently pointed to by the pointer encoding is overwritten by the write data at step 120.

If step 112 results in a miss, then it is determined whether there are any data storage locations available at step 122. If not, then an eviction process similar to that of step 116 is performed at step 124. In particular, an eviction victim is selected from the data storage locations and evicted to make a data storage location (and a corresponding tag storage location) available. At step 126, the new address tag (corresponding with the memory address specified in the write request) is allocated and the associated data field 48 is set to the pointer encoding to indicate the available data storage location. The write data is also allocated to that data storage location.

The general functionality of the eviction circuitry 56 has already been described in relation to the previous examples. The eviction circuitry 56 may select eviction victims in dependence on eviction victim priority metadata stored in association with the tag ways 42. As described above, this may be contained within a metadata field 50 of the tag entry 44. Alternatively, the eviction victim priority metadata may be stored in separate victim ways that are equal in number to the tag ways 42. Hence, the cache may track eviction victim priority metadata at a greater level of associativity that the data ways 40. Further alternatively, a single storage structure may be provided that is capable of tracking information for each tag way. For example, where there are M tag ways, then the priority metadata storage may comprise log₂(M) bits, where the resulting binary value identifies a tag way that is to be evicted next.

Furthermore, where the eviction circuitry 56 causes evicted data to be allocated into a lower level of cache, an evicted compressed entry (i.e. tag entry with a compressed-data encoding) may be kept in compressed form if the lower level of cache is also capable of supporting the compressed-data encoding. As described above, although FIG. 2A was described with reference to the level one data cache 30, the same arrangement of data ways 40 and tag ways 42 may be implemented in the level two cache 32. It will be appreciated that the level two cache 32 may include a larger number of data ways 40 and cache ways 42, and/or may include a different indexing scheme to allow for a larger number of sets 38 in each way. Therefore, when evicting a tag entry with a compressed-data encoding from the level one data cache 30, that tag entry may be allocated into the level two cache 32 without decompressing the data. In other words, the compressed-data encoding can be passed between the caches instead of passing the full cache line containing the predetermined value. Accordingly the traffic between caches is reduced and the memory system bandwidth may be used more efficiently.

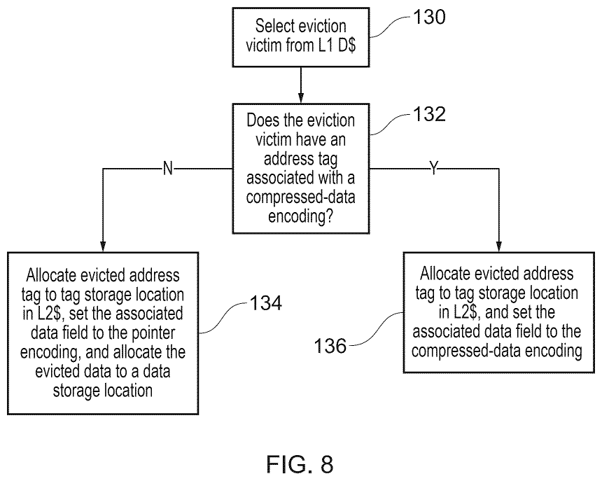

FIG. 8 illustrates a sequence of steps for the eviction circuitry 56 to evict an entry to a lower level of cache. At step 130, an eviction victim is selected from the level one data cache 30. As above, this selection may be performed in dependence on the eviction victim priority metadata and whether an incoming cache line to be allocated contains the predetermined value. At step 132, it is determined whether the eviction victim has an address tag associated with a compressed-data encoding. If not (i.e. the cache line for the eviction victim is held in a data storage location) then at step 134, the evicted address tag is allocated to a tag storage location, and the evicted data is allocated to a data storage location of the level two cache 32. The associated data field 48 of the tag storage location is set to the pointer encoding to point to the data storage location. If the eviction victim does have an address tag associated with a compressed-data encoding, then at step 136, the evicted address tag is allocated to a tag storage location in the level two cache, and the associated data field 48 of the tag storage location is set to the compressed-data encoding. The level two cache 32 may also be provided with compression control circuitry that operates similar to the compression control circuitry 52 described above. Hence, when allocating the address tag to the tag storage location in the level two cache at step 136, the storage of data to any of the data storage locations is suppressed. Accordingly, the abovementioned advantages for increasing the effective capacity of the cache at comparatively little hardware cost is also applicable to the level two cache 32. It will be appreciated that the above process could also be implemented when evicting the tag address from the level two cache 32 into a level three cache.

In some examples, it may be desired to deactivate the compression functionality of the present techniques. For example, when secure data is being handled, reverting to a conventional use of the cache by storing data in the data storage locations may be preferable to avoid giving potential hints of the contents of the data. For example, if storing data as compressed-data encodings in the tag storage locations, the overall usage of the cache may not change (e.g. because no data had to be evicted from the data storage locations). This could give a hint to an attacker that the secure data contains the predetermined value, thereby compromising security. Accordingly, when secure data is being handled by a secure process, the data processing apparatus 2 may switch to a machine state (e.g. by writing machine state data to a system register). The compression control circuitry 52 may then be responsive to that machine state to suppress setting the data field 48 to the compressed-data encoding. In other words, the data field 48 is only set to the pointer encoding and the data is allocated to the data storage locations. While the compression functionality is deactivated, it may still be permitted to read compressed data as described with reference to FIG. 6.

In some examples, the compression control circuitry 52 may be configured to not apply the present techniques to particular data types. In particular, micro-architectural metadata, such as memory protection tags, prefetcher metadata, etc. may rarely be the predetermined value and/or may be timing sensitive (e.g. the storage and retrieval of the data in the cache must meet certain timing requirements, where compression is likely to interfere with those requirements). Accordingly, the compression control circuitry 52 may be responsive to a determination that a cache line to be allocated to the cache contains this data, to set the associated data field 48 to a pointer encoding and to allocate the cache line to a data storage location.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

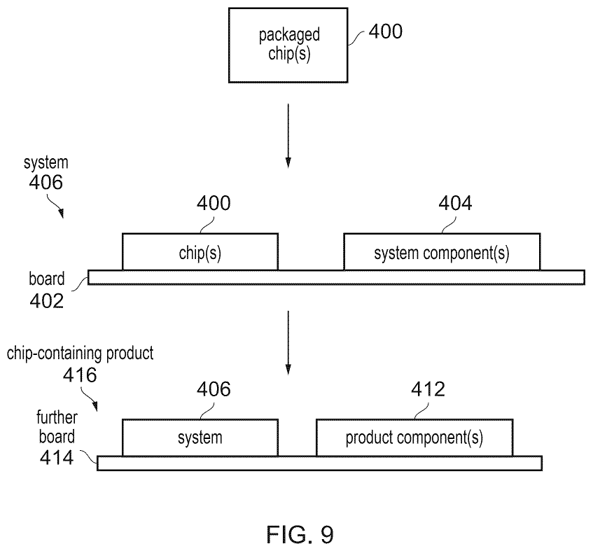

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

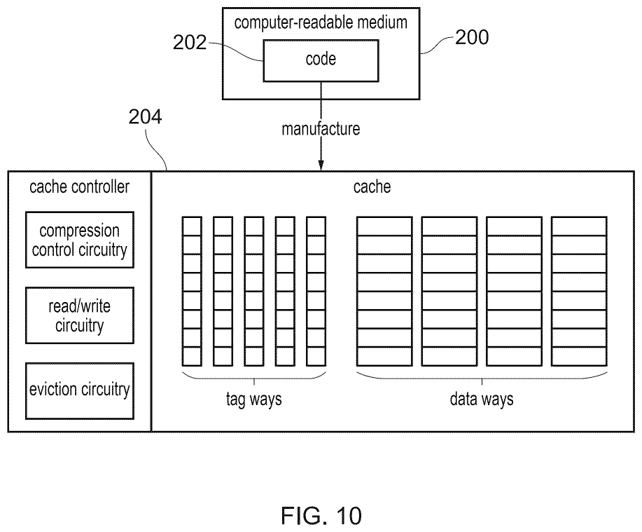

FIG. 10 illustrates an example of concepts described herein embodied in computer-readable code 202 for fabrication of an apparatus 204 that embodies the described concepts. For example, the computer-readable code 202 can be used at one or more stages of a semiconductor design and fabrication process, including an electronic design automation (EDA) stage, to fabricate an integrated circuit comprising the apparatus 204 embodying the concepts. The above computer-readable code may additionally or alternatively enable the definition, modelling, simulation, verification and/or testing of an apparatus 204 embodying the concepts described herein.

For example, the computer-readable code 202 for fabrication of an apparatus 204 embodying the concepts described herein can be embodied in code defining a hardware description language (HDL) representation of the concepts. For example, the code 202 may define a register-transfer-level (RTL) abstraction of one or more logic circuits for defining an apparatus 204 embodying the concepts. The code 202 may define a HDL representation of the one or more logic circuits embodying the apparatus 204 in Verilog, System Verilog, Chisel, or VHDL (Very High-Speed Integrated Circuit Hardware Description Language) as well as intermediate representations such as FIRRTL. Computer-readable code 202 may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code 202 may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code 202 a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code 202 may comprise a mix of code representations for fabrication of an apparatus 204 (or indeed just any component of the apparatus 204), for example including a mix of one or more of an RTL representation, a netlist representation, or another computer-readable definition to be used in a semiconductor design and fabrication process to fabricate an apparatus 204 embodying the invention. Alternatively or additionally, the concept may be defined in a combination of a computer-readable definition to be used in a semiconductor design and fabrication process to fabricate an apparatus 204 and computer-readable code 202 defining instructions which are to be executed by the defined apparatus once fabricated.

Such computer-readable code can be disposed in any known transitory computer-readable medium 200 (such as wired or wireless transmission of code over a network) or non-transitory computer-readable medium 200 such as semiconductor, magnetic disk, or optical disc. An integrated circuit fabricated using the computer-readable code 202 may comprise components such as one or more of a central processing unit, graphics processing unit, neural processing unit, digital signal processor or other components that individually or collectively embody the concept.

Some examples of the present invention are set out in the following clauses:
(1) An apparatus comprising:
a cache comprising:
   N data storage locations, configured to hold cache lines; and
   M tag storage locations, configured to hold address tags of cache lines, wherein each address tag is associated with a data field configured to support at least one of:
      a pointer encoding to indicate one of the N data storage locations into which a corresponding cache line is allocated; and
      a compressed-data encoding to represent a predetermined value;
   and
compression control circuitry responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.
(2) the Apparatus of Clause (1), Wherein M>N.
(3) The apparatus of clause (1) or clause (2), wherein the compression control circuitry is responsive to a determination that the given cache line does not contain the predetermined value to permit the given cache line to be allocated into a selected one of the N data storage locations, and set the data field of a selected tag storage location to the pointer encoding to indicate the selected one of the N data storage locations.
(4) The apparatus of any preceding clause, comprising:
   read circuitry configured to receive a read request to read target data at a requested memory address,
   wherein in response to identifying a hit address tag corresponding to the requested memory address and the data field associated with the hit address tag containing the compressed-data encoding, the read circuitry is configured to provide the predetermined value as a response to the read request.
(5) The apparatus of clause (4), wherein the read circuitry is configured to provide the predetermined value without accessing the N data storage locations.
(6) The apparatus of clause (4) or (5), wherein in response to the data field associated with the hit address tag containing the pointer encoding, the read circuitry is configured to retrieve the target data from the one of the N data storage locations indicated by the pointer encoding.
(7) The apparatus of any preceding clause, comprising:
   write circuitry configured to receive a write request to write target data to a specified memory address,
   wherein the write circuitry is responsive to identifying a target address tag corresponding to the specified memory address and associated with the data field containing the compressed-data encoding to:
      in a case where the target data is not the predetermined value, set the data field associated with the target address tag to the pointer encoding indicating an available one of the N data storage locations and to allocate the write target data into the available one of the N data storage locations.
(8) The apparatus of clause (7), wherein the write circuitry is responsive to a determination that there are no available data storage locations, to cause an existing cache line to be evicted from one of the N data storage locations.
(9) The apparatus of clause (7) or clause (8), wherein in a case where the write target data is the predetermined value:
   the write circuitry is configured to set the data field associated with the target address tag to the compressed-data encoding.
(10) The apparatus of any preceding clause, comprising:
   eviction circuitry configured to select an eviction victim to be evicted from the cache in response to the given cache line being allocated into the cache,
   wherein the eviction circuitry is configured to select the eviction victim in dependence on whether the given cache line to be allocated contains the predetermined value.
(11) The apparatus of clause (10), wherein,
   the cache comprises priority metadata storage configured to hold eviction victim priority metadata in association with each of the M tag storage locations,
   wherein the eviction circuitry is configured to select the eviction victim in dependence on the eviction victim priority metadata.
(12) The apparatus of clause (10) or clause (11), wherein in response to the given cache line containing the predetermined value, the eviction circuitry is configured to prioritise, for selection of the eviction victim, address tags associated with the compressed-data encoding.
(13) The apparatus of any of clause (10) to (12), wherein in response to the given cache line not containing the predetermined value, the eviction circuitry is configured to prioritise, for selection of the eviction victim, address tags associated with the pointer encoding.
(14) The apparatus of any preceding clause, comprising:
   a second cache, configured to store entries that are evicted from the cache, wherein the second cache comprises at least one second tag storage location configured to store an address tag in association with a second data field configured to support at least the compressed-data encoding, wherein
   in response to the cache evicting an entry comprising an address tag associated with the compressed-data encoding from one of the M tag storage locations, the second cache is configured to store the entry in the at least one second tag storage location and to set the second data field to the compressed-data encoding.
(15) The apparatus of any preceding clause, wherein the predetermined value is one of:
   all zeroes; and
   all ones.
(16) The apparatus of any preceding clause, wherein, in at least one of the M tag storage locations, the data field is configured to exclusively support the compressed-data encoding.
(17) The apparatus of any preceding clause, wherein the compression control circuitry is configured to suppress setting the data field to the compressed-data encoding in response to a given machine state.
(18) The apparatus of clause (17), wherein the given machine state is determined based on a value stored in a system register.
(19) The apparatus of any preceding clause, wherein the compression control circuitry is configured to suppress setting the data field to the compressed-data encoding in response to the given cache line containing a predetermined type of data.
(20) The apparatus of clause (19), wherein the predetermined type of data is one of:
   memory protection tags;
   prefetcher metadata;
   data that is already held in at least one further cache.
(21) a system comprising:
   the apparatus of any preceding clause, implemented in at least one packaged chip;
   at least one System component; and
   a board,
wherein the at least one packaged chip and the at least one system component are assembled on the board.
(22) A chip-containing product comprising the system of clause (21), wherein the system is assembled on a further board with at least one other product component.
(23) A method comprising:
   holding cache lines in N data storage locations;
   holding address tags of cache lines in M tag storage locations, wherein each address tag is associated with a data field supporting at least one of:
      a pointer encoding to indicate one of the N data storage locations into which a corresponding cache line is allocated; and
      a compressed-data encoding to represent a predetermined value;
   and
   in response to determining that a given cache line to be allocated into the cache contains the predetermined value, setting the data field associated with a given address tag corresponding to the given cache line to the compressed-data encoding to represent the predetermined value and suppressing storage of the given cache line in any of the N data storage locations.
(24) A non-transitory computer-readable medium storing computer-readable code for fabrication of an apparatus comprising:
a cache comprising:
   N data storage locations, configured to hold cache lines; and
   M tag storage locations, configured to hold address tags of cache lines, wherein each address tag is associated with a data field configured to support at least one of:
   a pointer encoding to indicate one of the N data storage locations into which a corresponding cache line is allocated; and
      a compressed-data encoding to represent a predetermined value;
   and
   compression control circuitry responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.

In brief overall summary, apparatuses, systems, methods, computer-readable media, and computer code are disclosed. An apparatus comprises a cache comprising N data storage locations to hold cache lines; and M tag storage locations to hold address tags of cache lines. Each address tag is associated with a data field configured to support at least one of: a pointer encoding to indicate one of the N data storage locations into which a corresponding cache line is allocated and a compressed-data encoding to represent a predetermined value. Compression control circuitry is responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

1. An apparatus comprising:
a cache comprising:
N data storage locations, configured to hold cache lines; and
M tag storage locations, configured to hold address tags of cache lines, wherein each address tag is associated with a data field configured to support-at a pointer encoding to indicate one of the N data storage locations into which a corresponding cache line is allocated; and
a compressed-data encoding to represent a predetermined value;
and compression control circuitry responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.

2. The apparatus of claim 1, wherein M >N.

3. The apparatus of claim 1, wherein the compression control circuitry is responsive to a determination that the given cache line does not contain the predetermined value to permit the given cache line to be allocated into a selected one of the N data storage locations, and set the data field of a selected tag storage location to the pointer encoding to indicate the selected one of the N data storage locations.

4. The apparatus of claim 1, comprising:
read circuitry configured to receive a read request to read target data at a requested memory address, wherein in response to identifying a hit address tag corresponding to the requested memory address and the data field associated with the hit address tag containing the compressed-data encoding, the read circuitry is configured to provide the predetermined value as a response to the read request.

5. The apparatus of claim 4, wherein the read circuitry is configured to provide the predetermined value without accessing the N data storage locations.

6. The apparatus of claim 4, wherein in response to the data field associated with the hit address tag containing the pointer encoding, the read circuitry is configured to retrieve the target data from the one of the N data storage locations indicated by the pointer encoding.

7. The apparatus of claim 1, comprising:
write circuitry configured to receive a write request to write target data to a specified memory address, wherein the write circuitry is responsive to identifying a target address tag corresponding to the specified memory address and associated with the data field containing the compressed-data encoding to:
in a case where the target data is not the predetermined value, set the data field associated with the target address tag to the pointer encoding indicating an available one of the N data storage locations and to allocate the write target data into the available one of the N data storage locations.

8. The apparatus of claim 7, wherein the write circuitry is responsive to a determination that there are no available data storage locations, to cause an existing cache line to be evicted from one of the N data storage locations.

9. The apparatus of claim 7, wherein in a case where the write target data is the predetermined value:
the write circuitry is configured to set the data field associated with the target address tag to the compressed-data encoding.

10. The apparatus of claim 1, comprising:
eviction circuitry configured to select an eviction victim to be evicted from the cache in response to the given cache line being allocated into the cache, wherein the eviction circuitry is configured to select the eviction victim in dependence on whether the new given cache line to be allocated contains the predetermined value.

11. The apparatus of claim 10, wherein, the cache comprises priority metadata storage configured to hold eviction victim priority metadata in association with each of the M tag storage locations, wherein the eviction circuitry is configured to select the eviction victim in dependence on the eviction victim priority metadata.

12. The apparatus of claim 10, wherein in response to the given cache line containing the predetermined value, the eviction circuitry is configured to prioritise, for selection of the eviction victim, address tags associated with the compressed-data encoding.

13. The apparatus of claim 10, wherein in response to the given cache line not containing the predetermined value, the eviction circuitry is configured to prioritise, for selection of the eviction victim, address tags associated with the pointer encoding.

14. The apparatus of claim 1, comprising:
a second cache, configured to store entries that are evicted from the cache, wherein the second cache comprises at least one second tag storage location configured to store an address tag in association with a second data field configured to support at least the compressed-data encoding, wherein in response to the cache evicting an entry comprising an address tag associated with the compressed-data encoding from one of the M tag storage locations, the second cache is configured to store the entry in the at least one second tag storage location and to set the second data field to the compressed-data encoding.

15. The apparatus of claim 1, wherein the predetermined value is one of:
all zeroes; and
all ones.

16. (canceled)

17. A system comprising:
the apparatus of claim 1, implemented in at least one packaged chip;
at least one system component; and
a board, wherein the at least one packaged chip and the at least one system component are assembled on the board.

18. A chip-containing product comprising the system of claim 17, wherein the system is assembled on a further board with at least one other product component.

19. A method comprising:
holding cache lines in N data storage locations;
holding address tags of cache lines in M tag storage locations, wherein each address tag is associated with a data field supporting-at a pointer encoding to indicate one of the N data storage locations into which a corresponding cache line is allocated; and
a compressed-data encoding to represent a predetermined value;
and in response to determining that a given cache line to be allocated into the cache contains the predetermined value, setting the data field associated with a given address tag corresponding to the given cache line to the compressed-data encoding to represent the predetermined value and suppressing storage of the given cache line in any of the N data storage locations.

20. A non-transitory computer-readable medium storing computer-readable code for fabrication of an apparatus comprising:
a cache comprising:
N data storage locations, configured to hold cache lines; and
M tag storage locations, configured to hold address tags of cache lines, wherein each address tag is associated with a data field configured to support-at a pointer encoding to indicate one of the N data storage locations into which a corresponding cache line is allocated; and
a compressed-data encoding to represent a predetermined value;
and compression control circuitry responsive to a determination that a given cache line to be allocated into the cache contains the predetermined value, to set the data field associated with a given address tag corresponding to the given cache line to the compressed-data encoding to represent the predetermined value, and to suppress storage of the given cache line into any of the N data storage locations.
